(19) United States
(12) Patent Application Publication
(10) Pub. No.: US 2009/0133502 A1
(43) Pub. Date: May 28, 2009

(54) Document Monitoring Device

(75) Inventors: Alexandre Gret, Spiegel (CH); Ronald Bruce Blair, Flower Mound, TX (US)

Correspondence Address: OLIFF & BERRIDGE, PLC, P.O. BOX 320850, ALEXANDRIA, VA, 22320-4850, US

(73) Assignee: De La Rue International Limited, Basingstoke, GB (GB)

(21) Appl. No.: 12/086,862

(22) PCT Filed: Dec. 21, 2006
(86) PCT No.: PCT/GB2006/004871

§ 371 Date: Aug. 18, 2008

(30) Foreign Application Priority Data
Dec. 23, 2005 (GB) 0526381.9

(51) Int. Cl. G01N 29/27; B06B 1/06

(52) U.S. Cl. 73/633; 367/140

(57) ABSTRACT

A document monitoring device comprises an ultrasonic transmitter (20) and an ultrasonic receiver (22) positioned on opposite sides of a document inspection position. A control system (5) is coupled to the ultrasonic transmitter (20) and receiver (22) for causing ultrasonic signals to be transmitted from the transmitter to the receiver through the inspection position and for monitoring the ultrasonic signals received by the receiver. At least one of the receiver (22) and transmitter (20) comprises a piezoelectric polymer film (32, 34).

The invention relates to a document monitoring device comprising an ultrasonic transmitter and an ultrasonic receiver positioned at a document inspection position; and a control system coupled to the ultrasonic transmitter and receiver for causing ultrasonic signals to be transmitted from the transmitter to the receiver through the inspection position and for monitoring the ultrasonic signals received by the receiver. Such devices are hereinafter referred to as of the kind described.

Document monitoring devices of the kind described utilizing ultrasonic signals have been developed relatively recently to inspect documents such as banknotes.

Measuring paper thickness and/or tape on banknotes makes use of the high impedance contrast between air and banknote/tape to ultrasound. Hence, the percentage of reflected energy is a measure of banknote density. This method can distinguish between single banknotes and doubles, as well as detect tape, holes, tears and cuts.

As the ultrasonic wave hits the banknote, some of its energy will be reflected and some will propagate through the note. The ratio between the reflected and transmitted energy is approximately a measure of the impedance contrast. It is important to note that absorption is frequency dependent. Hence the design and piezoelectric material chosen will affect the measured frequency band and the related absorption of air and banknote paper.

Conventionally, ultrasound has been generated using piezoelectric materials that can convert electrical energy into ultrasound energy and vice versa. Commonly used piezoelectric transducers are built from ceramic materials (e.g. PZT, BaTiO₂) or quartz.

An example of a conventional ultrasonic based system for monitoring banknotes is described in PCT/GB 06/002947.

Conventional piezoelectric transducers based on ceramics and the like have a housing which surrounds the ceramic material in order to support it and through which connections are made to a control system. The size of the housing means that it is not possible to place a set of piezoelectric transducers side by side and have a continuous sensitive region either for transmitting or receiving ultrasound. In an attempt to deal with this, it is known to provide a number of linear arrays of transducers with the transducers of one array being laterally staggered with respect to the transducers of an adjacent array so that each transducer of the staggered array is in alignment with a gap between transducers of the first array. However, even with this arrangement, it is possible for certain defects in documents to be missed, particularly tears since full coverage transverse to a document feed direction cannot be achieved.

Another problem with conventional transducers is that they are designed to emit ultrasound with a very small frequency bandwidth and hence high Q-factor. In the context of document monitoring, particularly of banknotes, this is undesirable because it has been found that the document material such as paper responds in different ways to different frequencies and it is important to be able to monitor the response of the document to a wide range of frequencies.

In accordance with the present invention, a document monitoring device of the kind described is characterised in that at least one of the receiver and transmitter comprises a piezoelectric polymer film.

We have found that a significant improvement of conventional document monitoring devices can be achieved by making use of piezoelectric polymer film to constitute one or both of the receiver and transmitter. The use of this film is known in medical and seismic fields but the significance of this material in the field of document monitoring has not been previously recognized. In particular, the use of a film enables full coverage of a document to be achieved since the film can extend fully across the document path without any gaps in contrast to the known ceramic transducer arrays. In addition, the film has an inherently low Q-factor and can generate a broad bandwidth of frequencies making it particularly suitable to inspect documents at different frequencies. This also enables high resolution images to be obtained.

Another advantage of using piezoelectric polymer films is that the shape of the film can be adapted to a wide variety of applications in contrast to the relatively rigid nature of conventional ceramic transducers. This is important in document handling devices where the document path may extend around curves and the like and the piezoelectric material can be designed to follow those curves.

Another advantage of the low Q-factor property of the piezoelectric polymer films is that the ring-down time is much shorter than with ceramic transducers. This increases in line resolution significantly and delivers broadband data.

Although in some cases, one of the receiver and transmitter could be made using conventional ceramic or quartz transducers, preferably, each of the receiver and transmitter comprises a piezoelectric polymer film.

Examples of suitable films include Polyvinylidene difluoride, Co-polymer of vinylidene fluoride and trifluoroethylene, Co-polymer of vinylidene fluoride and tetrafluoroethylene, and Co-polymer of vinylidene cyanide and vinylacetate.

The piezoelectric polymer film can be configured in a number of different ways. In the preferred approach, said at least one of the receiver and transmitter comprises a support member defining a cavity, the piezoelectric polymer film extending across the cavity. The cavity allows the film to vibrate and the size of the cavity affects the main vibration frequency.

In an alternative arrangement, said at least one of the receiver and transmitter comprises a support member defining a convex surface over which the piezoelectric polymer film extends.

In either case, the support member is preferably electrically conductive so as to provide a convenient way of providing electrical contact with the adjacent surface of the film. A suitable example is aluminium. Alternatively, a lead can be taken through the support member, for example, to contact the adjacent surface of the film.

One or both of the transmitter and receiver, if made from piezoelectric polymer film, could comprise a sequence of respective polymer films but in the preferred example, at least one of the transmitter and receiver, preferably the transmitter, comprises a single piezoelectric polymer film. In practice, this single film will extend across a document transport path, preferably orthogonally thereto.

The transmitter and receiver may be positioned so as to detect-ultrasound reflected from a document but, preferably, they are positioned on opposite sides of the document inspection position.

As has been mentioned above, the invention is particularly suited for use in a document handling device comprising a document transport for transporting documents through an inspection position, the document monitoring device being located at the inspection position.

In this case, the control system is preferably responsive to the monitored ultrasonic signals to provide an output signal related to a characteristic of the document being monitored. For example, the control system may identify the presence of one or more of a tape or tear on or in the document or the passage of more than one document in an overlapped manner.

Conveniently, the document handling device further comprises a routing device, such as a diverter, downstream of the inspection position, the routing device being responsive to the output signal from the control system to route documents in a predetermined manner depending upon the determined characteristic of the document.

The document handling device may comprise a document acceptor, a document, dispenser, or a document recycler and the invention is particularly applicable to devices adapted to handle documents of value such as banknotes.

Some examples of document monitoring devices according to the invention will now be described with reference to the accompanying drawings, in which:—

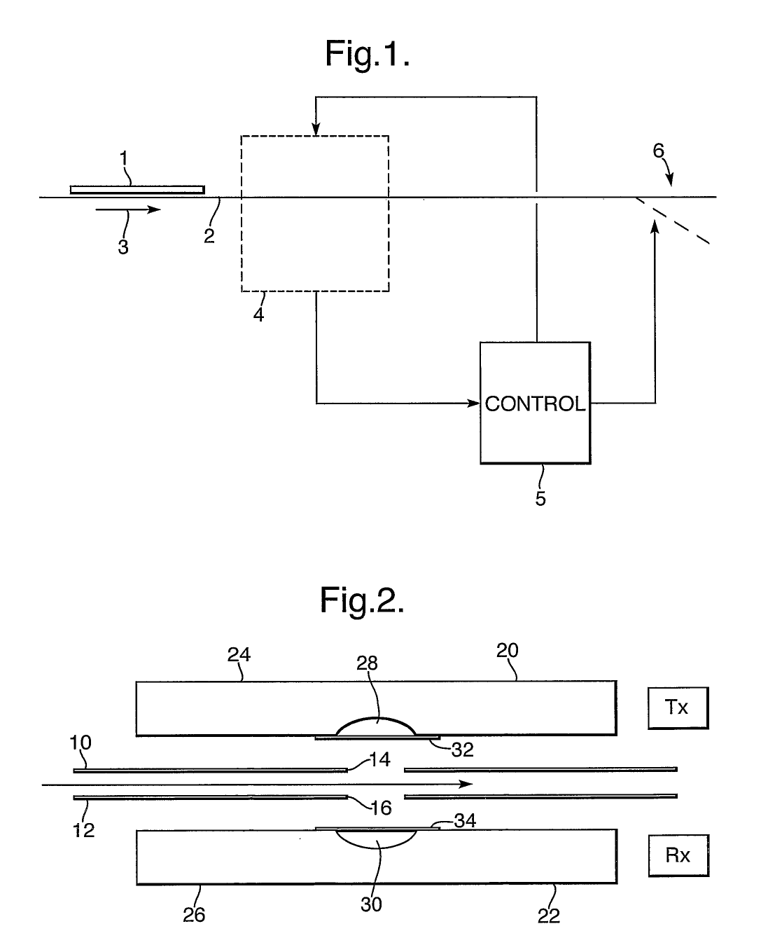

FIG. 1 is a schematic diagram of part of a banknote handling device;

FIG. 2 illustrates the transmitter and receiver arrangement of the inspection position of FIG. 1 in more detail but with some parts omitted for clarity;

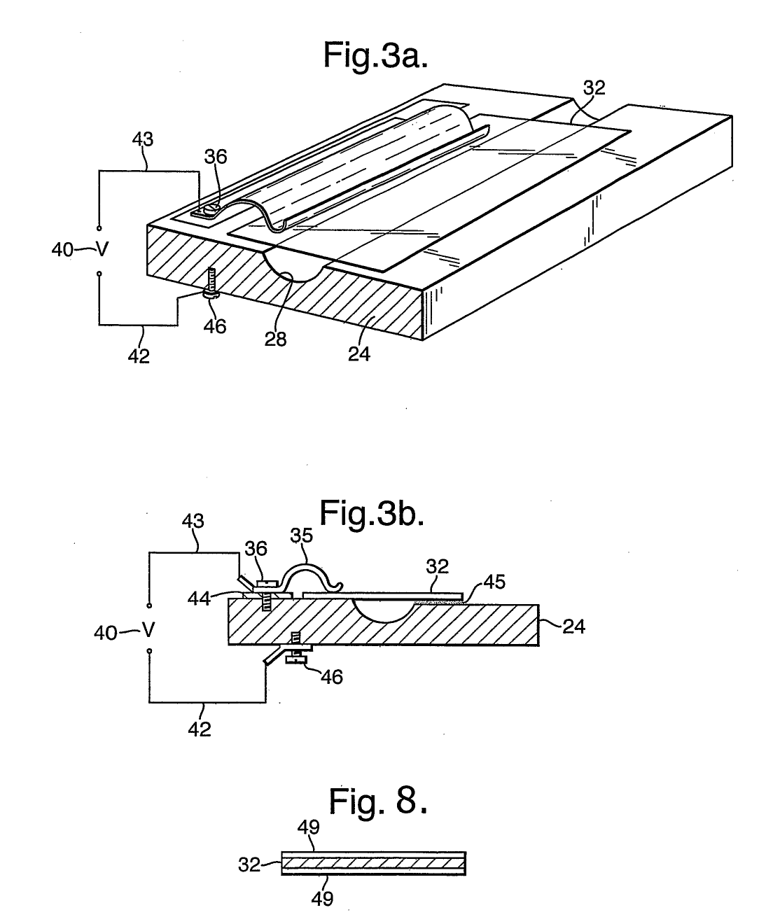

FIG. 3a is a schematic, perspective view of the transmitter shown in FIG. 2;

FIG. 3b is a schematic cross-section of the transmitter shown in FIG. 2;

FIG. 4 is a schematic circuit diagram of the transmitter and receiver circuits used with the transmitter and receiver of FIG. 2;

FIG. 5 illustrates an alternative structure for a transmitter or receiver;

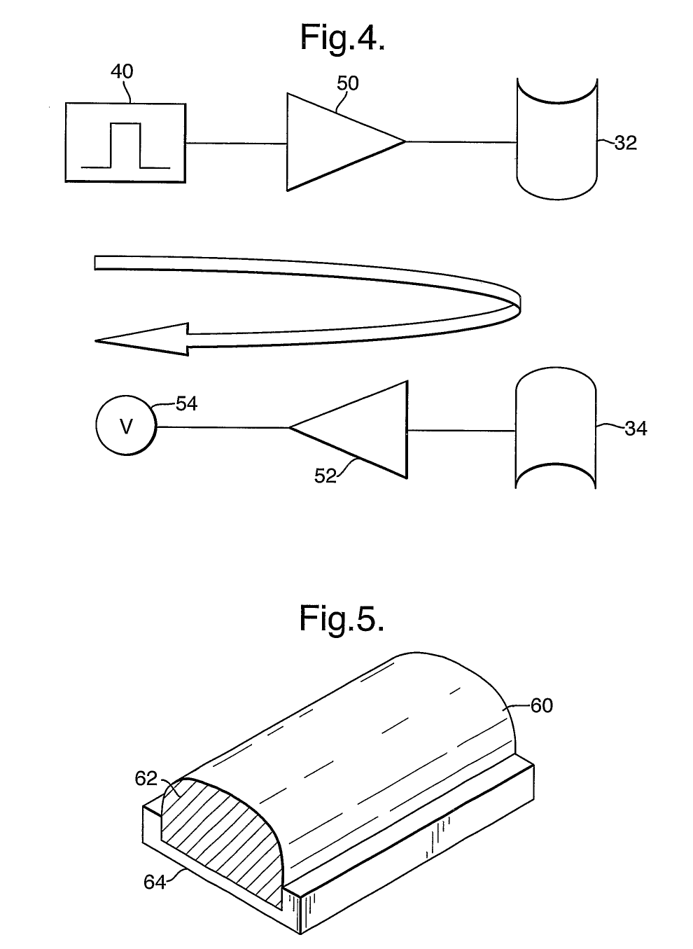

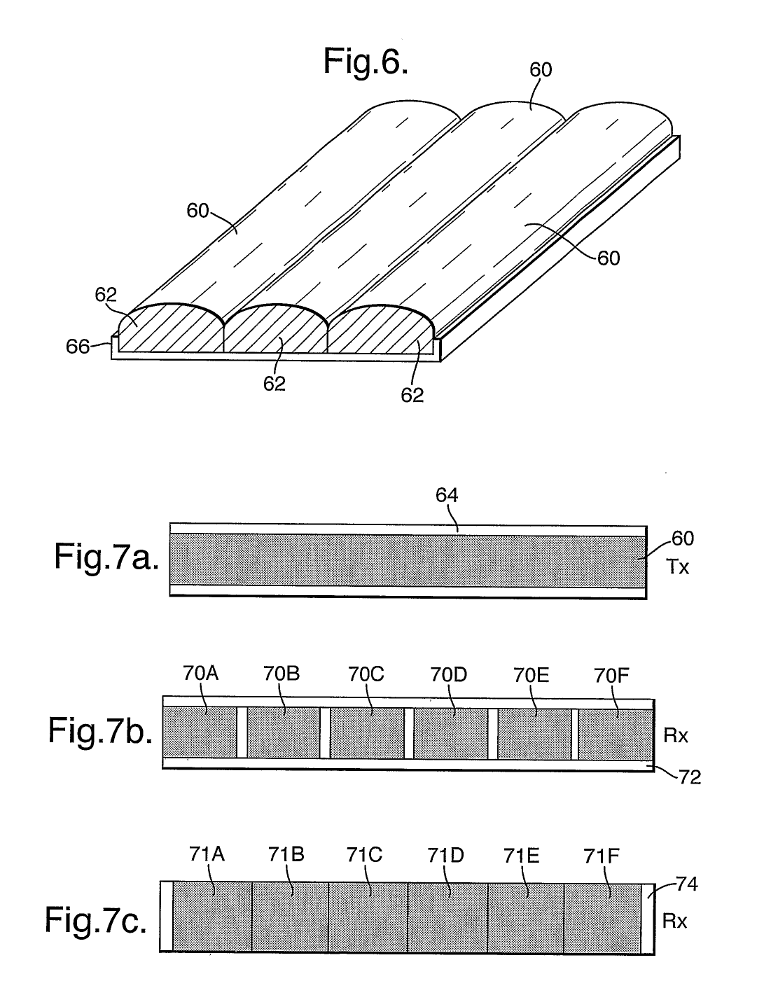

FIG. 6 illustrates an alternative array structure for a transmitter or receiver;

FIG. 7a illustrates an example of a transmitter while FIGS. 7b and 7c show alternative structures for a receiver for use with the transmitter of FIG. 7a; and,

FIG. 8 is a schematic cross-section through a piezoelectric film.

In this description, we will illustrate examples of document monitoring devices in the context of a banknote handling device such as a banknote acceptor, recycler, sorter or the like. In such devices, banknotes 1 (FIG. 1) are supplied from a source (not shown) such as an acceptor slot and are transported along a transport path 2 in the direction of an arrow 3. The banknotes pass through an inspection position indicated by dashed lines 4 where they are subjected to ultrasonic inspection (to be described below) so as to detect unacceptable conditions such as the presence of a tape or tear on or in the banknote, overlapped banknotes and the like. The resultant information is processed by a control system 5 which then selectively activates a diverter member 6. If the banknote is acceptable, the diverter member 6 is set to the position shown in solid line and the banknote is fed along the transport path for further processing. Alternatively, if an unacceptable condition is sensed then the diverter member 6 is moved to the position shown in dashed lines and the banknote is directed towards a reject location (not shown).

The structure of the inspection position is shown in more detail in FIG. 2. Running through the inspection position are upper and lower guide members 10, 12 between which the banknotes are fed in a conventional manner such as by using a conveyor belt system. The guide members 10, 12 have respective, aligned inspection apertures 14, 16. A transmitter assembly 20 is located above the upper guide 10 and a corresponding receiver assembly 22 below the lower guide 12. Each assembly comprises a conductive support block 24,26 respectively, for example made of aluminium, and defining an elongate concave cavity 28,30.

An elongate piezoelectric polymer film 32,34 is secured across the respective cavities 28,30. Details of the securement method are not shown in FIG. 2.

It will be seen that the cavities 28,30 and films 32,35 are aligned with the apertures 14, 16 in the guides 10, 12. This means that ultrasonic signals generated by the transmitter assembly, to be described below, are transmitted towards the aperture 14 and will then pass through any banknote present between the cavities 14, 16. The transmitted ultrasound then passes through the cavity 16 and is received by the receiver 22.

In order to cause the transmitter to transmit ultrasound, it is necessary to cause the film 32 to vibrate. This is achieved by applying a voltage across the thickness of the piezoelectric polymer film. There are a number of different ways in which a voltage can be applied across the film and one method is shown in FIG. 3. In this method, a voltage source 40 is coupled by a wire 42 and screw 46 to the underside of the support block 24. Since the support block 24 is conductive, the voltage will therefore be applied to the underside of the piezoelectric polymer film 32. In order to achieve this, the film 32 must be adhered by a conductive adhesive to the support block 24.

Contact with the upper surface of the piezoelectric polymer film 32 can be achieved by means of a spring contact strip clamp 35 (FIGS. 3a and 3b) which is anchored to an upper surface of the support block 24 by non-conducting screws 36 (only one shown in FIG. 3a). The spring contact strip clamp 35 is coupled via a wire 43 to the voltage source 40.

In order to ensure that there is no electrical contact between the anchored end of the clamp 35 and the support block 24, an insulating pad 44 is provided between them.

The side of the piezoelectric film 32 opposite from that clamped by the clamp 35 is secured to the surface of the support block 24 by a conductive adhesive 45.

FIG. 8 illustrates schematically a typical structure for the piezoelectric film 32 showing that the film is coated on opposite surfaces by a conductive coating 49.

In order to cause the transmitter to transmit, a high voltage (typically several hundreds of volts) is applied from a source 40 under control of the control system 5 to opposite surfaces of the piezoelectric polymer film 32. This causes elongation of the polymer film and since an alternating voltage is applied, the film will vibrate over the air cavity 28 and generate an airborne, ultrasonic wave. The frequency of this wave is related to the frequency and magnitude of the applied voltage signal and the shape and size of the air cavity 28.

FIG. 4 illustrates an example of a circuit for use with the transmitting and receiving assemblies. On the transmitter side, the signal generator 40 which typically generates a low voltage signal of about 20 Vpp maximum is applied to a HV amplifier 50 where the voltage is amplified up to 300 Vpp before being applied to the polymer film 32. The broadband ultrasonic signal is then emitted in a burst mode with a known energy level. Ultrasound received at the receiver 22 causes vibration of the piezoelectric polymer film 34. This vibration is converted into a voltage signal which is picked up using contacts similar to those shown in FIGS. 3a, 3b for the transmitter, the voltage signal being fed to a signal amplifier 52 and from there to a measurement circuit 54 where the signal is integrated and the power level determined. The signal from the measurement circuit 54 is then digitized and then fed to the control system 5 which then processes the signal to determine whether or not the monitored banknote is acceptable. In some cases, a time “window” can be applied to the received signals to make sure than no echoes remain in the measurement. As is described in more detail in our co-pending International Patent Application No. PCT/GB 06/002947, if a banknote enters the gap between the cavities 28,30, only a small portion of the energy is transmitted to the receiver and this portion relates to the material properties of the banknote and can be used to detect the presence of tapes, tears and the like.

It will be noted from FIG. 2 that the transmitter and receiver 25,22 are protected from engagement with the banknote by means of the guides 10, 12. Furthermore, no acoustic absorbing material is necessary in this case since the piezoelectric films 32,34 have a low Q and hence the film 34 will absorb all the incoming ultrasonic energy.

In typical examples, the films 32,34 have a thickness of about 25 microns while the frequency of the ultrasound will typically lie between 10 and 300 kHz. The cavities 28,30 will typically be semi-cylindrical with a radius of between 1 and 2 mm.

In the example described above, each film 32,34 is provided across a respective cavity 28,30. FIG. 5 illustrates an alternative structure in which a film 60 is wrapped around a convex, conductive support block 62 and secured in place by means of a non-conductive U-shaped channel member 64. The film 60 will vibrate in a radial mode similar to a loudspeaker membrane. Electrical contact with the opposite surfaces of the film 60 can be achieved in a variety of ways. Typically, one contact is made through the conductive support member 62 while contact with the other, outer side of the film 60 is achieved through one of the sides of the U-shaped channel member 64. This is not shown in FIG. 5.

The transducer shown in FIG. 5 can, of course, be used in either transmitter or receiver modes.

FIG. 6 illustrates a transducer assembly made up of three transducers of the type shown in FIG. 5 but with a single U-shaped channel member 66. This transducer array can be used, on the transmitter side, to form a narrower beam pattern than with a single film. Similar arrays could be achieved by using additional films and cavities in the examples of FIGS. 2 and 3.

In the examples described so far, a single piezoelectric polymer film has been used for each of the transmitter and receiver. This extends fully across the transport path, orthogonally thereto, so as to provide complete coverage of a banknote. By suitably sampling the received ultrasound, a complete map of the banknote as it passes through the inspection position can be derived. However, although this enables the presence of a defect of a tape or tear to be detected, the location of that tape or tear in a direction transverse to the transport direction cannot be determined.

In order to increase resolution in the direction transverse to the transport direction, one of the receiver and transmitter can be broken down into smaller component parts with a polymer film polarized in one direction. Thus ultrasonic energy not aligned with the polarization direction will not be detected. This is illustrated in FIG. 7. FIG. 7a illustrates a transmitting transducer of the type shown in FIG. 5.

FIG. 7b illustrates one example of a receiver construction based on a plurality of transducers 70A-70F of the type shown in FIG. 5 with the elongate axis of each film 60 being coaxial, the films being mounted on respective members (not shown in FIG. 7b) within a common U-shaped channel member 72.

FIG. 7c illustrates an alternative arrangement for the receiver transducer in which an array of receiving transducers 71A-71F of the type shown in FIG. 5 are arranged with the axes of the piezoelectric polymer films 60 parallel with one another. Again, the films 60 and support blocks 62 (not shown in FIG. 7c) are mounted in a common U-shaped channel member 74.

In each case, the individual transducers 70A-70F and 71A-71F are coupled to respective amplifiers and measurement circuits 52,54 of the type shown in FIG. 4 so that the ultrasonic signals received by each can be individually detected and processed. This then enables the position of a defect transverse to the transport direction to be identified.

Of course, it would be possible to reverse the arrangement such that one of the arrays shown in FIGS. 7b and 7c is used as a transmitter and the array in FIG. 7a used as a receiver.

In addition, two detector arrays could be provided, one in accordance with each of FIGS. 7a and 7b.

Typically, in the case of a banknote handling device, where the dimension transverse to the transport direction to be monitored is about 190 mm, 16 individual receiving transducers will be used corresponding to 16 channels.

1. A document monitoring device comprising an ultrasonic transmitter and an ultrasonic receiver positioned at a document inspection position, wherein the inspection position is located on a document transport path along which documents are transported in a transport direction in use; and a control system coupled to the ultrasonic transmitter and receiver for causing ultrasonic signals to be transmitted from the transmitter to the receiver through the inspection position and for monitoring the ultrasonic signals received by the receiver wherein at least one of the receiver and transmitter comprises a piezoelectric polymer film that extends fully across the transport path.

2. A device according to claim 1, wherein each of the receiver and transmitter comprises a piezoelectric polymer film.

3. A device according to claim 1, wherein the piezoelectric polymer film is one of Polyvinylidene difluoride, Co-polymer of vinylidene fluoride and trifluoroethylene, Co-polymer of vinylidene fluoride and tetrafluoroethylene, and Co-polymer of vinylidene cyanide and vinylacetate.

4. A device according to claim 1, wherein opposite surfaces of the or each piezoelectric polymer film are coupled to respective electrodes of the control system.

5. A device according to claim 1, wherein said at least one of the receiver and transmitter comprises a support member defining a cavity, the piezoelectric polymer film extending across the cavity.

6. A device according to claim 1, wherein said at least one of the receiver and transmitter comprises a support member defining a convex surface over which the piezoelectric polymer film extends.

7. A device according to claim 5, wherein the piezoelectric polymer film is at least partly adhered to the support member.

8. A device according to claim 7, wherein the adhesive is a conductive adhesive.

9. A device according to claim 5, wherein the piezoelectric polymer film is partly adhered to the support member and partly urged against the surface of the support member by an electrode.

10. A device according to claim 5, wherein the support is electrically conductive.

11. A device according to claim 10, wherein the support is made of aluminium.

12. A device according to claim 1, the device comprising an array of ultrasonic receivers, each comprising a respective piezoelectric polymer film, the array being aligned with the transmitter.

13. A device according to 12, wherein each piezoelectric polymer film is curved about an axis, the axis being aligned with the axis of the transmitter.

14. A device according to claim 12, wherein each piezoelectric polymer film is curved about an axis, the axis being orthogonal to the axis of the transmitter.

15. A device according to claim 12, wherein the transmitter comprises an elongate piezoelectric polymer film extending in alignment with a linear array of ultrasonic receivers.

16. A device according to claim 12, the device comprising an array of said transmitters, each comprising a respective piezoelectric polymer film, the array being aligned with the receiver.

17. A device according to claim 1, wherein the inspection position is located on a document transport path along which documents are transported in a transport direction in use, the transmitter comprising a piezoelectric polymer film and extends across, preferably orthogonally with respect to, the transport direction.

18. A device according to claim 17, wherein the receiver comprises a piezoelectric polymer film that extends across the transport path in alignment with the transmitter.

19. A device according to claim 1, wherein the ultrasonic transmitter and ultrasonic receiver are positioned on opposite sides of the document inspection position.

20. A document handling device comprising a document transport for transporting documents through an inspection position; and a document monitoring device comprising an ultrasonic transmitter and an ultrasonic receiver positioned at a document inspection position, wherein the inspection position is located on a document transport path along which documents are transported in a transport direction in use; and a control system coupled to the ultrasonic transmitter and receiver for causing ultrasonic signals to be transmitted from the transmitter to the receiver through the inspection position and for monitoring the ultrasonic signals received by the receiver wherein at least one of the receiver and transmitter comprises a piezoelectric polymer film that extends fully across the transport path, the document monitoring device being located at the inspection position.

21. A device according to claim 20, wherein the control system is responsive to the monitored ultrasonic signals to provide an output signal related to a characteristic of the document being monitored.

22. A device according to claim 21, wherein the control system identifies the presence of one or more of a tape or tear on or in the document or the passage of more than one document in an overlapped manner.

23. A device according to claim 21, further comprising a routing device, such as a diverter, downstream of the inspection position, the routing device being responsive to the output signal from the control system to route documents in a predetermined manner depending upon the determined characteristic of the document.

24. A device according to claim 20, the device comprising one of a document acceptor, a document dispenser, and a document recycler.

25. A device according to claim 20, the device being adapted to handle documents of value such as banknotes.
